(19) United States
(12) Patent Application Publication
(10) Pub. No.: US 2025/0377512 A1
(43) Pub. Date: Dec. 11, 2025

(54) SLACK STORAGE BASKET WALL EXPANDER

(71) Applicant: PREFORMED LINE PRODUCTS CO., Mayfield Village, OH (US)

(72) Inventor: Michael Avery, Eastlake, OH (US)

(21) Appl. No.: 19/229,310

(22) Filed: Jun. 5, 2025

Related U.S. Application Data
(60) Provisional application No. 63/657,549, filed on Jun. 7, 2024.

(51) Int. Cl. G02B 6/44

(52) U.S. Cl. CPC G02B 6/4442

(57) ABSTRACT

An enclosure to house a connection includes a closure base and a closure cover to define an interior space. A slack storage basket within the interior space includes a floor portion, a first side portion attached to the floor portion and a second side portion attached to the floor portion. The floor portion, the first side portion, and the second side portion define a volume configured to contain a length of a cable, wherein the connection is associated with at least some of the cable. A third side portion and a fourth side portion are selectively attachable to the first side portion and the second side portion, respectively, to increase a dimension of the slack storage basket. When at least one of the third side portion or the fourth side portion are attached to the slack storage basket, the volume is increased to store an increased length of the cable.

### RELATED APPLICATION

Priority is claimed from U.S. Application No. 63/657,549, the entire disclosure of which is incorporated herein by reference.

### FIELD

The present disclosure relates generally to splice closures, sometimes referred to as terminal, splice closures, or drop boxes, and associated methods, for use in communications, such as fiber optic communications.

Moreover, the present disclosure is directed to organization and storage within enclosures. Enclosures of the type under consideration are particularly suited for enclosing and housing fiber optic cables such as loose buffer and unitube type cables. However, the enclosures could equally well be used with other types of cables or wires such as, for example, hybrid cables including copper wire, twisted pair wire, and/or co-axial cables.

### BACKGROUND

An enclosure (e.g., a splice closures or drop box) may be used at a distribution point and/or a building entry point for the communications cables. Within such an enclosure, fusion splicing, direct termination, patching and/or the like may be performed and the closure provides housing and thus protection for such. Often, splitting also occurs within the enclosure. In some instances, a terminal with which the enclosure is associated is a network interface unit connecting a location/area to an overall network.

Service providers (i.e., communication companies) may provide fiber optic links, or similar, directly to a home, business, apartment, etc. via use of enclosures and the fusion splicing, direct termination, patching or the like contained therein. Different locations, or a location at different points in time, may be associated with different needs concerning organization and storage within the associated enclosures.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

In accordance with some aspects, an enclosure to house a connection includes a closure base partially defining an interior space of the enclosure. The closure base defines a point of entry for an incoming portion of a cable to enter into the interior space of the enclosure. The enclosure also includes a closure cover mating with the closure base. The closure cover partially defines the interior space such that the closure cover and the closure base define the interior space of the enclosure, the interior space being for the connection, wherein the connection is associated with at least some of the cable. The enclosure includes a slack storage basket located within the interior space. The slack storage basket includes a floor portion and a first side portion attached to the floor portion. The first side portion extends a first dimension measured from an intersection of the floor portion and the first side portion taken along a first line oblique to the floor portion. The slack storage basket also includes a second side portion attached to the floor portion. The second side portion extends a second dimension measured from an intersection of the floor portion and the second side portion taken along a second line oblique to the floor portion. The floor portion, the first side portion, and the second side portion define a volume configured to contain a length of the cable and a portion of one or more outgoing cables, the volume defined by the first dimension, the second dimension, a third dimension of the floor portion measured from a first end of the first side portion to a second end of the first side portion, and a fourth dimension of the floor portion measured from the first side portion to the second side portion. The enclosure includes a third side portion selectively attachable to the first side portion to increase the first dimension. The enclosure also includes a fourth side portion selectively attachable to the second side portion to increase the second dimension. When at least one of the third side portion or the fourth side portion are attached to the slack storage basket, the volume is increased to store an increased length of the cable than when at least one of the third side portion or the fourth side portion are not attached to the slack storage basket.

In accordance with some aspects, the present disclosure provides an enclosure to house a connection. The enclosure includes a closure base partially defining an interior space of the enclosure. The closure base includes a point of entry for an incoming portion of a cable to enter into the interior space of the enclosure. The enclosure also includes a closure cover mating with the closure base, the closure cover partially defining the interior space. The closure cover and the closure base define the interior space of the enclosure, the interior space being for the connection, wherein the connection is associated with at least some of the cable. The enclosure includes a slack storage basket located within the interior space. The slack storage basket includes a floor portion and a first side portion attached to the floor portion. The first side portion extends a first dimension measured from an intersection of the floor portion and the first side portion taken along a first line oblique to the floor portion. The slack storage basket also includes a second side portion attached to the floor portion. The second side portion extends a second dimension measured from an intersection of the floor portion and the second side portion taken along a second line oblique to the floor portion. The floor portion, the first side portion, and the second side portion define a volume configured to contain a length of the cable and a portion of one or more outgoing cables. The volume is defined by the first dimension, the second dimension, a third dimension of the floor portion measured from a first end of the second side portion to a second end of the second side portion, and a fourth dimension of the floor portion measured from the first side portion to the second side portion. The slack storage basket includes a third side portion attached to the first side portion. The third side portion is movable from a first position to a second position. The slack storage basket includes a fourth side portion attached to the second side portion. The fourth side portion is movable from a third position to a fourth position. When the third side portion is moved from the first position to the second position, the first dimension is increased, and when the fourth side portion is moved from the third position to the fourth position, the second dimension is increased. When at least one of the first dimension or the second dimension is increased, the volume is increased to store an increased length of the cable than when at least one of the first dimension or the second dimension is not increased.

In accordance with some aspects, the present disclosure provides a wall for a slack storage basket having a first dimension. The wall includes a bottom side facing a first side portion of the slack storage basket. The wall also includes a first connecting structure associated with the bottom side of the wall. The first connecting structure is configured to cooperate with a second connecting structure attached to the slack storage basket. Location of the bottom side of the wall proximate the first side portion of the slack storage basket places the first connecting structure in cooperation with the second connecting structure to attach the wall to the slack storage basket. When the wall is attached to the slack storage basket, the first dimension of the slack storage basket is increased in order to increase a volume defined by the slack storage basket such that an increased length of a cable may be stored in the slack storage basket as compared to when the wall is not attached to the slack storage basket.

In accordance with some aspects, the present disclosure provides a kit for adding volume to a slack storage basket of an enclosure. The kit includes a first wall having a first bottom side. The kit also includes a second wall having a second bottom side. The first bottom side of the first wall is selectively attached to a first side portion of the slack storage basket. The second bottom side of the second wall is selectively attached to a second side portion of the slack storage basket. When the first bottom side of the first wall is attached to the first side portion, a first dimension of the slack storage basket is increased. When the second bottom side of the second wall is attached to the second side portion, a second dimension of the slack storage basket is increased. When at least one of the first dimension or the second dimension is increased, a volume of the slack storage basket of the enclosure is increased to store an increased length of a cable than when at least one of the first dimension or the second dimension is not increased.

### DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is a partially disassembled perspective illustration of a known example enclosure, with an exterior portion disassembled from a remainder of the closure to expose an example known interior portion with an example storage and some example cables extending therein.

FIG. 2 is a perspective illustration of the exposed, interior portion of FIG. 1 and specifically shows a known storage tray as the example storage without example cables therein.

FIG. 3 is a perspective illustration of a known interior portion similar to the portion shown in FIG. 2, but with an example storage area being an area partially bounded by known brackets.

FIG. 4 is a perspective illustration of an example interior portion of an enclosure showing a slack storage basket in accordance with an aspect of the present disclosure.

FIG. 5A is a perspective illustration of an example capture feature attached to a first side portion of the slack storage basket.

FIG. 5B is a reverse angle perspective of the capture feature of FIG. 5A.

FIG. 6A is a perspective illustration of an example retention tab feature of a structure attached to the slack storage basket.

FIG. 6B is a reverse angle perspective of the retention tab feature of FIG. 6B.

FIG. 7 is a perspective illustration similar to FIG. 4 showing tray support tabs.

FIG. 8 is a perspective illustration similar to FIG. 7 showing removal of the tray support tabs from the slack storage basket.

FIG. 9 is a perspective illustration of an example wall expander for use with the slack storage basket according to FIG. 4.

FIG. 10 is a perspective illustration similar to FIG. 8, showing two wall expanders according to FIG. 9 to provide an increased volume to the storage tray in accordance with an aspect of the present disclosure.

FIG. 11 is a pair of perspective illustrations similar to FIG. 4 with some components removed showing a wall expander according to FIG. 9 having a selectively slidable attachment to the storage tray.

FIG. 12 is a perspective illustration similar to FIG. 11, but showing a wall expander having a selectively rotatable attachment to the storage tray.

FIG. 13 is a perspective illustration of an example interior portion of an enclosure similar to FIG. 4, but shows an option of adding additional wall expanders upon already placed wall expanders.

FIG. 14 is a perspective illustration similar to FIG. 13, with the two wall expanders in place and the tabs in place such that additional portions (e.g., one or more splice trays) may be added in accordance with an aspect of the present disclosure.

FIG. 15 is a perspective illustration similar to FIG. 12, but showing a splice tray supported by the tabs in accordance with an aspect of the present disclosure.

FIG. 16 is a reverse-angle perspective illustration of the example interior portion shown in FIG. 15.

FIG. 17 is a perspective illustration similar to FIG. 16, but showing a storage tray and a splice tray of different dimension and number of tabs in accordance with an aspect of the present disclosure.

FIG. 18 is a perspective illustration of an example interior portion of an enclosure showing a hook and loop fastener.

### DETAILED DESCRIPTION

The claimed subject matter is now described with reference to the drawings, wherein like reference numerals are used to refer to like elements throughout. In the following description, for purposes of explanation, numerous specific details are set forth in order to provide an understanding of the claimed subject matter. It is evident, however, that the claimed subject matter may be practiced without these specific details. In other instances, structures and devices are illustrated in block diagram form in order to facilitate describing the claimed subject matter. Relative size, orientation, etc. of parts, components, etc. may differ from that which is illustrated while not falling outside of the scope of the claimed subject matter.

In summary, the present disclosure describes structures, methods, and kits utilizing a wall expander within an enclosure (e.g., splice closure) to increase a volume of a slack storage basket within the enclosure. The increased volume of the slack storage basket enables storage of greater length of cable (e.g., feed cable, slack cable, etc.) within the slack storage basket without requiring a replacement of either of the existing slack storage basket or the existing enclosure. The wall expander is secured to an interface of a wall of the slack storage basket in order to change (e.g., increase) a dimension of the slack storage basket in order to increase the volume of the slack storage tray enabling storage of greater length of slack cable within the slack storage basket. It is to be appreciated that while slack cable may be referenced herein, the instant disclosure is not to be limited to the same. Rather, any cable is contemplated herein. The slack storage basket and the wall expander can include at least one capture feature that promotes a modular system such that multiple wall expanders can be added to the slack storage basket as desired. In other words, the wall expander can interface or cooperate with additional wall expanders as needed to increase the dimension as needed.

The capture features of the slack storage basket and the wall expander can be selectively separated such that any given wall expander can be removed from the slack storage basket and/or another wall expander as needed. The wall expander can include features for stability such that the wall expander remains in-line with at least one wall of the slack storage basket and other wall expanders. The stability feature can be a part of the capture feature or an additional feature of the wall expander. A dimension representing a length of the wall expander can vary in order in order to match a length dimension of the slack storage basket. Similarly, a second dimension representing a height of the wall expander can vary to increase a total height dimension of the slack storage basket as desired in order to provide more available storage volume within the slack storage basket.

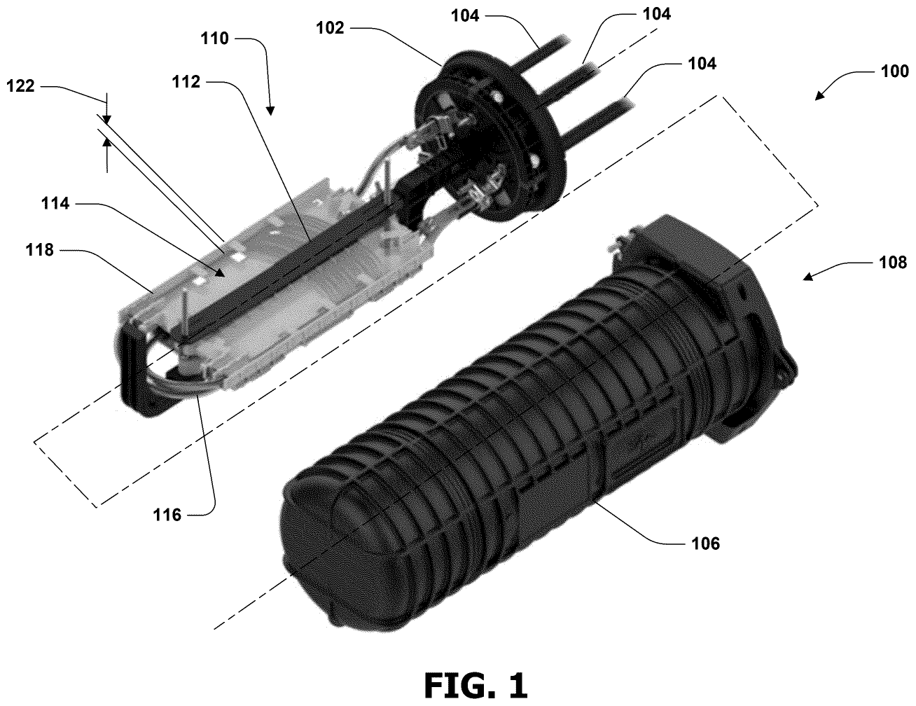

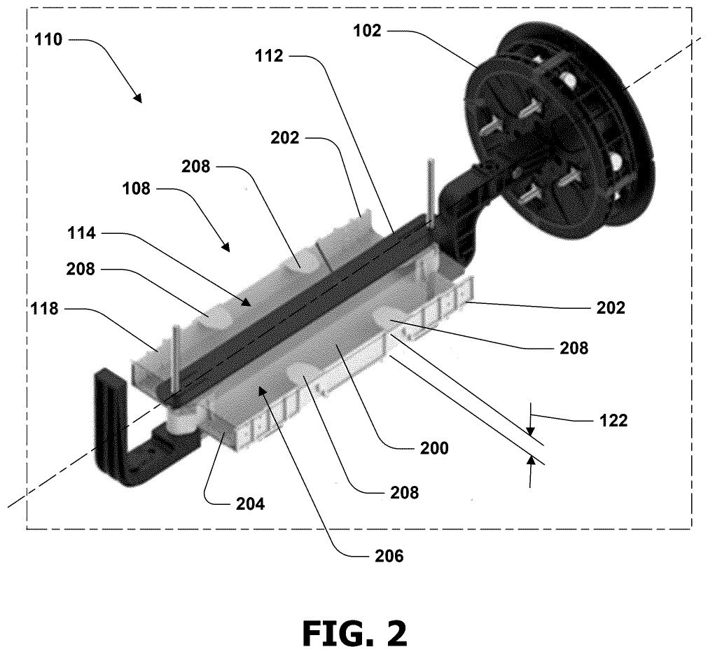

A known example enclosure 100 (e.g., splice closure) is shown in FIG. 1. The enclosure 100 includes a base 102 through which one or more cables 104 and/or the like extend. It is to be appreciated that such cable(s) can come from any location, any direction, any entry point, etc. and all of such is contemplated herein. In some examples, the cable(s) 104 is fiber optic material that is part of a distribution network of fiber optic wire originating at a central source and extending to end user locations (e.g., businesses, schools, residences, etc.). The enclosure 100 is to be mounted to another, mount object (e.g., a wall of a structure, a utility pole, or similar). A cover portion 106 (e.g., a dome) mates with the base 102 to enclose an interior space 108. Within the interior space 108, an interior portion 110 of the enclosure 100 is provided (the interior portion is shown removed from the interior space). The interior portion 110 (shown in both FIG. 1 and FIG. 2) may include one or more splice trays (shown in later figures). Within the shown example, the splice trays would be placed below (as viewed in FIG. 1 and FIG. 2) of a hold-down strap 112. One or more connection (e.g., of one or more cables) may be made, housed, etc. in the interior space 108.

The interior portion 110 may also include a volume designated for storage 114, within which a length of cable 116 or the like may be located and retained. An example of some example cable 116 being within the storage 114 is shown within FIG.

1. Of course, the storage 114 may also be for (i.e., holding thereof) buffer tube or similar. Such may be dependent upon the particular cable, tube, etc. being routed to, within or out of the enclosure 100.

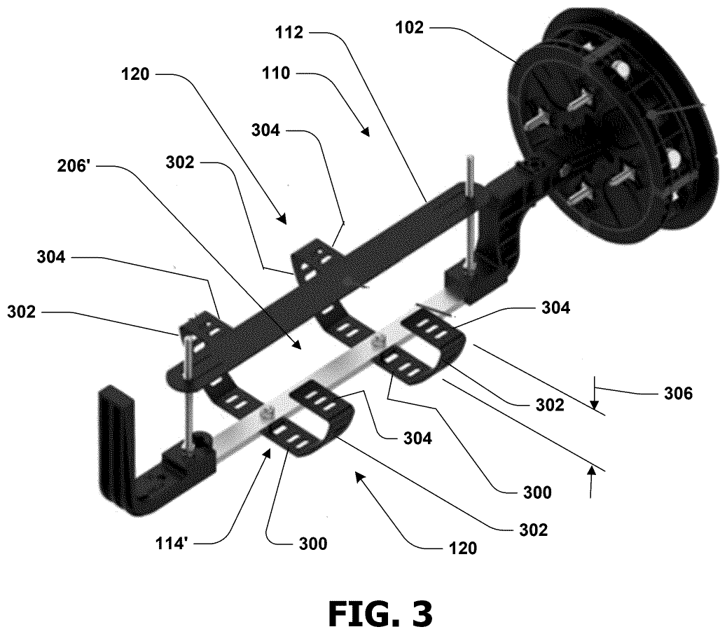

The storage 114 may be defined/provided via a tray (e.g., a plastic tray or metal tray) 118, as shown within FIG. 2 or provided via brackets (e.g., metal brackets or plastic brackets) 120 as shown within FIG. 3. It is to be appreciated that the example of FIG. 3 is similar to the example of FIG. 2 and as such some similar structures are identified via a same reference numeral, but with a “′” (prime) added. The example of FIG. 3 shows that a different storage 114′ may be provided. Moreover, for all such examples, the storage 114/114′ may be identified via various terminology, such as a storage basket, a slack basket, a slack storage basket, a transition tray, etc.

Focusing upon the example of FIG. 2, the tray 118 that provides the storage 114 may be identified via several other names such as tray, basket, bin, etc. The tray 118 has a bottom (as oriented within FIG. 2) wall 200 and two vertically extending side or lateral walls 202. In some examples, the tray 118 includes two vertically extending end walls 204. The example shown in FIG. 2 includes only one of the end walls 204, however, it is to be understood that the tray 118 can include an end wall 204 at an end proximate the base 102 and at a distal end in relation to the base 102. As such, a volume 206 is bounded therein. Also, the tray 118 may have plural (e.g., four) support tabs 208 that extend inwardly from top edges from the side walls 202. Further, the tray 118 may have plural (e.g., two) support tabs 208 that extend inwardly from top edges from the end walls 204. The extent of each support tab 208 is over a portion of the bound volume 206. The support tabs 208 are at a height from the bottom wall 200 (i.e., the support tabs 208 are spaced from the bottom wall 200). Such support tabs 208 may help retain cable, tube, etc. within the storage 114 or the within the volume 206. In some examples, the strap 112 may help retain cable, tube, etc. within the storage 114.

Focusing upon the example of FIG. 3, the storage 114′ may be considered to be a volume 206′ within which the brackets 120 retain cable, tube, fiber optic components, etc. The shown example includes two brackets 120. Each bracket 120 includes a bottom segment 300 that extends laterally (as viewed within FIG. 3) while having upwardly extending (as viewed within FIG. 3) side segments 302. Also, each bracket 120 may include tab segments 304 that extend inwardly over a portion of the volume 206′ of the storage 114′. The tab segments 304 are at a height from the bottom segment 300 (i.e., the tab segments 304 are spaced from the bottom segment 300). Such tab segments 304 may help retain cable, tube, etc. within the storage 114′. Also, the strap 112 may help retain cable, tube, etc. within the storage 114′.

It is to be appreciated, each storage 114, 114′ (e.g., via tray/basket/brackets) has a fixed size (e.g., volume 206, 206′). Such is especially so in the context of a height/depth as measured in a vertical direction. As viewed in the example of FIG. 2, such height/depth is measured between the bottom of the storage and the support tabs 208 as represented by dimension 122. As viewed in the example of FIG. 3, such height/depth is measured between the bottom segment 300 and the tab segments 304 as represented by dimension 306.

It is contemplated that different enclosures may need different size (e.g., volume) for the storage 114, 114′. An example of circumstances that may be associated with different volume needs includes variations in the number and/or size of the cable, tube, etc. to be stored. In some examples, requirements for new fiber optic drops to new customers and/or new physical locations can increase the required volume 206, 206′ within the storage 114, 114′. The present disclosure describes structures and methods to increase the volume 206, 206′ while utilizing the same or a similar-sized cover portion 106 (e.g., using the same dome as was used prior to installing additional drops).

Also, it is contemplated that a particular enclosure 100 may need a different, and specifically a greater, size (e.g., volume 206, 206′) for the storage at a future point in time. As an example of circumstances that may be associated with a different, and specifically a greater, size (e.g., volume 206, 206′) for the storage 114, 114′ at a future point in time includes adding cable, tube, etc. to be stored in the future.

Returning to FIG. 1, it is to be appreciated that a given cover portion 106 will typically have a fixed interior volume as defined by the interior space 108. As a result, the described increase of volume 206, 206′ of the storage 114, 114′ can, in some examples, be brought about by simply making use of volume that was previously not occupied. In some examples, the described increase of volume 206, 206′ can require removal of other structures within the interior space 108. In some examples, the described increase of volume 206, 206′ can result from a combination of the previous two examples.

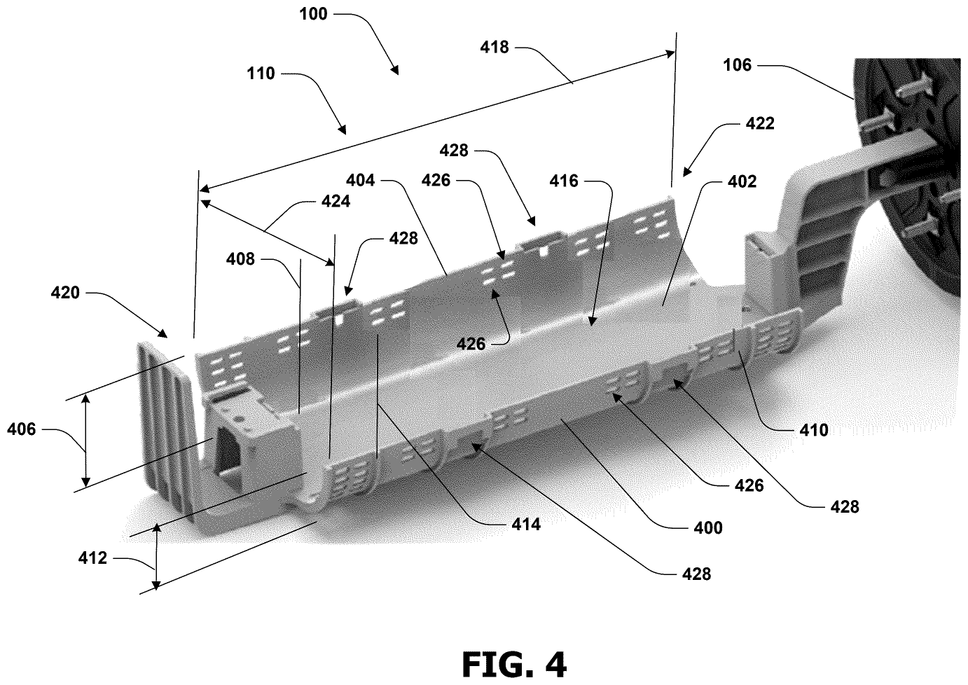

Referring to FIG. 4, a perspective view of an example interior portion 110 of an enclosure 100 showing a slack storage basket 400 is illustrated. The slack storage basket 400 can be attached to the cover portion 106 and can be constructed of any suitable material including plastic, metal, etc. As shown, the slack storage basket 400 can be located within the interior space 108 (shown in FIG. 1) during regular operation of the enclosure 100 and the cables 104 that form a portion of a distribution system. The slack storage basket 400 includes a floor portion 402 and a first side portion 404 attached to the floor portion 402. The first side portion 404 extends a first dimension 406 measured from an intersection of the floor portion 402 and the first side portion 404 taken along a first line 408 oblique to the floor portion 402. In some examples, the first line 408 is perpendicular to the floor portion 402.

The slack storage basket 400 also includes a second side portion 410 attached to the floor portion 402. The second side portion 410 extends a second dimension 412 measured from an intersection of the floor portion 402 and the second side portion 410 taken along a second line 414 oblique to the floor portion 402. In some examples, the second line 414 is perpendicular to the floor portion 402. In some examples, the first dimension 406 is equal to the second dimension 412. The floor portion 402, the first side portion 404, and the second side portion 410 define a volume 416 configured to contain a length of the cable 104 (shown in FIG. 1). The volume 416 can be defined by the first dimension 406, the second dimension 412, a third dimension 418 of the floor portion 402 measured from a first end 420 of the first side portion 404 to a second end 422 of the first side portion 404, and a fourth dimension 424 of the floor portion 402 measured from the first side portion 404 to the second side portion 410. In some examples, the third dimension 418 and the fourth dimension 424 are measured in directions perpendicular to each other.

Remaining with FIG. 4, at least one of the floor portion 402, the first side portion 404 or the second side portion 410 defines an aperture 426 configured to enable attachment of a component (not shown) to the slack storage basket 400 to limit relative motion between the component and the slack storage basket 400. Any number of components can be mounted to the slack storage basket 400, including, but not limited to devices to separate or organize the cable or wire stored within the slack storage basket 400. Any suitable number of apertures 426 can be defined by the individual components that form the slack storage basket 400.

At least one of the first side portion 404 or the second side portion 410 include a capture feature 428. The capture feature 428 enables a portion of the slack storage basket 400 (e.g., the first side portion 404, the second side portion 410, etc.) to engage or selectively attach a structure to be described below to the slack storage basket 400. In some examples, the capture feature 428 is configured to cooperate with the structure to help ensure structure can be selectively attached to the slack storage basket 400 and detached from the slack storage basket 400 as desired.

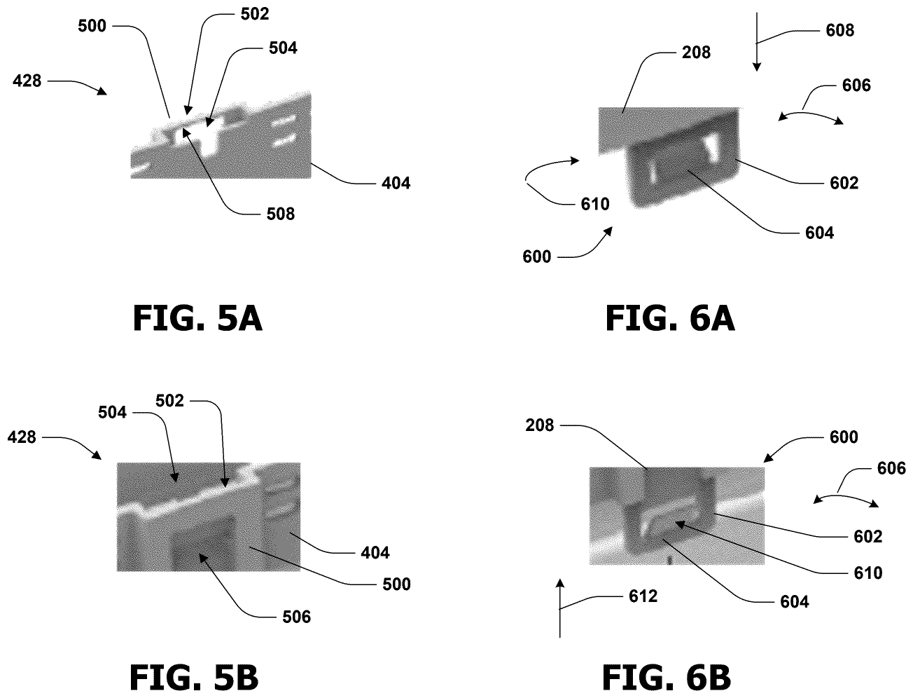

Referring to FIG. 5A, a detail perspective view of an example capture feature 428 is illustrated. The capture feature 428 is shown as viewed from the volume 416, 206′ space (e.g., an interior side of the first side portion 404). The capture feature 428 can include a wall 500 having a top surface 502, and the wall 500 is separated from the first side portion 404. Lateral ends of the wall 500 extend toward and attach to the first side portion 404 in order to attach the wall 500 to the first side portion 404. Separation of the wall 500 from the first side portion 404 defines an aperture 504 extending in a direction parallel or substantially parallel to the first line 408 (shown in FIG. 4).

Referring to FIG. 5B, a detail perspective view of the capture feature 428 is illustrated in a reverse angle from FIG. 5A. In other words, the wall 500 is shown using a view from a perspective exterior to the volume 416. As shown, the wall 500 can define an opening 506 that is spaced a distance from the top surface 502 of the wall 500.

Referring to FIG. 6A, a detail perspective view of an example retention tab feature 600 is illustrated. The retention tab feature 600 is shown as viewed from the volume 416 space similar to FIG. 5A (e.g., an interior side of the first side portion 404). The retention tab feature 600 is attached to a structure that was previously discussed above, such as, but not limited to, the support tab 208. The retention tab feature 600 can include a U-shaped wall 602 extending generally downward from the support tab 208. A retention tab 604 is attached to and extends away from the U-shaped wall 602 generally upward toward the support tab 208. In some examples, the attachment method of the retention tab 604 to the U-shaped wall 602 is somewhat flexible such that the retention tab 604 can elastically deflect (e.g., rotate from a first position) as shown by arrow 606. In some examples the attachment of the retention tab 604 to the U-shaped wall 602 can be rigid while the dimensions and material properties of the retention tab 604 enable the retention tab 604 to elastically deflect (e.g., move to a second position in a manner represented by arrow 606. In some examples, both the attachment method (e.g., a live hinge) and the material properties of the retention tab 604 enable the retention tab 604 to elastically deflect or deform.

As shown, the retention tab feature 600 of FIG. 6A cooperates with the capture feature 428 as shown in FIG. 5A. The U-shaped wall 602, when urged by a force represented by arrow 608, enters the aperture 504 shown in FIG. 5A. A face 610 of the retention tab 604 contacts a surface 508 of the wall 602 or an edge at the intersection of the top surface 502 and the surface 508. Further application of the force 608 urges the retention tab 604 to rotate or elastically deform toward the arrow 606 pointing to the right of FIG. 6A. As a top edge of the retention tab 604 passes the top portion of the opening 506, the retention tab 604 will elastically return to its original position (e.g., the first position) such that a portion of the retention tab 604 extends through the opening 506. This arrangement provides a physical interference preventing undesired separation of the retention tab feature 600 from the capture feature 428.

At such time when separation of the support tab 208 (or other structure comprising the retention tab feature 600) from any structure comprising a capture feature 428, an operator can simply elastically deform the retention tab 604 with a tool or through hand manipulation to eliminate the physical interference between the retention tab 604 and the capture feature 428, thus enabling detachment of the two structures from each other. In short, the reverse operation of the steps utilized to attach the two structures can be used to selectively separate the structures as many times as are desired.

Referring to FIG. 6B, a detail perspective view of the retention tab feature 600 is illustrated in a reverse angle from FIG. 6A. In other words, the retention tab feature 600 is shown using a view from a perspective exterior to the volume 416. As shown, the face 610 is visible unlike FIG. 6A where the face 610 is facing away from the viewer. As discussed previously, during the detachment operation, the retention tab 604 can be elastically deformed toward the left arrow 606 to remove the physical interference between the retention tab 604 and the capture feature 428. An applied force 612 is then applied to urge the retention tab feature 600 generally upward to remove the retention tab 604 from the capture feature 428. As shown, the retention tab feature 600 of FIG. 6B cooperates with the capture feature 428 as shown in FIG. 5B.

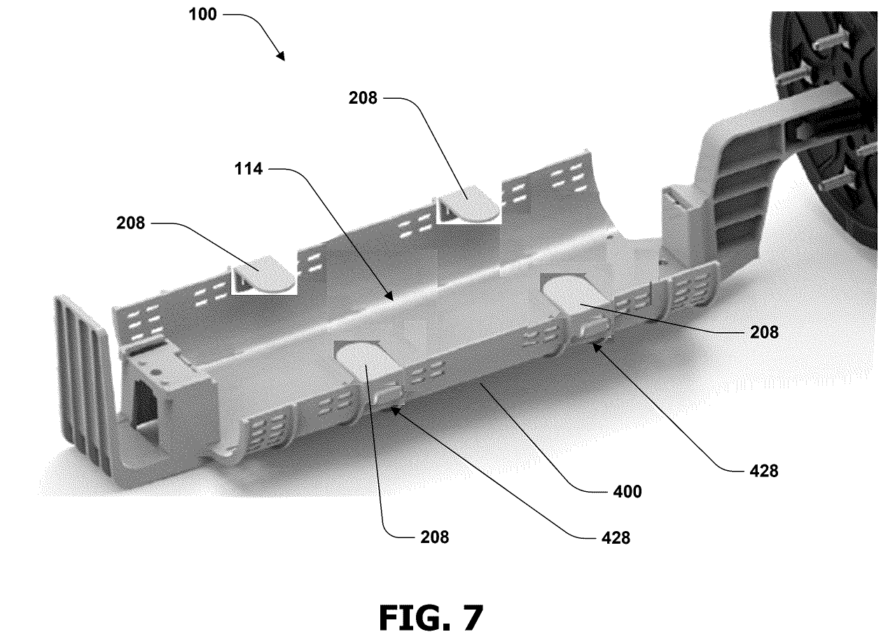

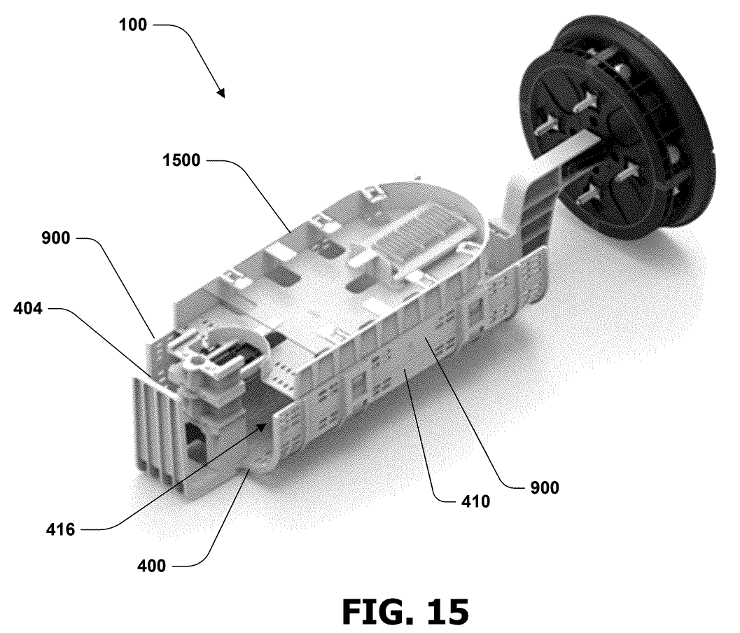

Referring to FIG. 7, a perspective view of the slack storage basket 400 showing a tray support tab 208 is illustrated. While FIG. 7 illustrates the use of four tray support tabs 208, any suitable number of tray support tabs 208 can be used with the present disclosure. The tray support tabs 208 can serve multiple functions, including, but not limited to, providing a physical boundary for the wire or cable stored within the storage 114 of the enclosure 100. The tray support tabs 208 can also provide a relatively firm base for a splice tray (an example is shown in FIG. 15) that may be stacked atop the slack storage basket 400. While some representations of the capture features 428 are removed from FIG. 7 for clarity, it is to be understood that the tray support tabs 208 can include retention tab features 600 which cooperate with capture features 428 on the slack storage basket 400. This cooperation selectively attaches the tray support tabs 208 to the slack storage basket 400 as discussed in reference to FIGS. 5A, 5B, 6A, and 6B.

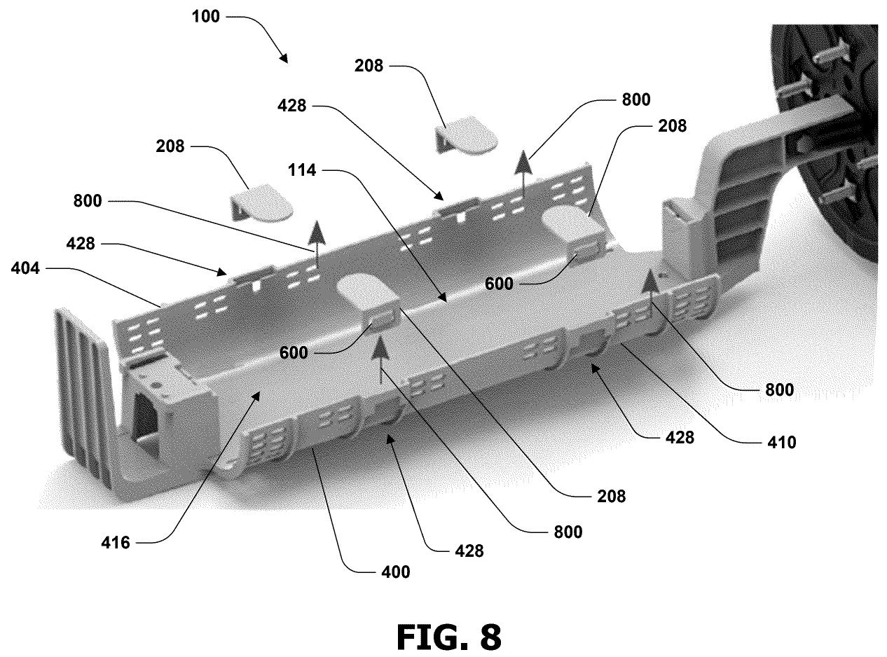

Referring to FIG. 8, a perspective view of the slack storage basket 400 showing detachment of the tray support tabs 208 from the slack storage basket 400 is illustrated. As previously discussed, there may be occasions when an increased volume 416 of the storage 114 is desired (e.g., more fiber optic cable drops are required at this portion of a network). In some examples, a replacement of the entire enclosure 100 is not desired, and thus more increased volume 416 for the storage 114 can be developed within the existing enclosure 100. The tray support tabs 208 can be detached from the slack storage basket 400 using the process previously discussed using the capture feature 428 and a cooperating retention tab feature 600. The arrows 800 show the direction of application of a force to urge the tray support tabs 208 to detach from the slack storage basket 400.

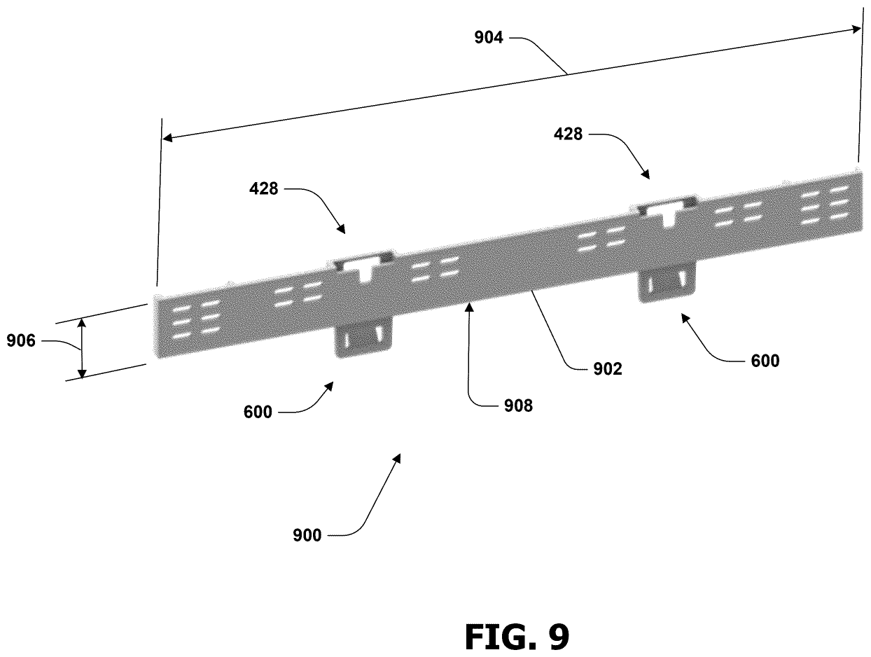

Referring to FIG. 9, an example wall expander 900 in accordance with an aspect of the present disclosure is illustrated. The wall expander 900 is to provide a solution to the above-mentioned fixed size (e.g., fixed volume) of storage 114 in accordance with an aspect of the present disclosure. As such, the wall expander 900, and possibly a plurality of wall expanders 900 are to be used within an enclosure 100 as discussed further following.

Although the wall expander 900, and the structures and functions thereof, will be more fully appreciated further following, the following discussion of just the wall expander 900 is provided, in accordance with an aspect of the present disclosure. The wall expander 900 includes a body 902 portion. Within the shown example, the body 902 is generally flat, with a rectangular outline when viewed from a side (e.g., a flat face). Moreover, the body 902 is elongate (i.e., one, elongate dimension 904 of the face is longer than a dimension 906 as measured perpendicular). Herein, such dimensions are referred to as the elongate dimension 904 and the perpendicular dimension 906. It is to be appreciated that the elongate dimension 904 and the perpendicular dimension 906 may be varied. The variation may be due in part to the particular enclosure 100 within which the wall expander 900 is to be used and/or a choice as to change of size of storage 114 as discussed further following.

It is to be appreciated that the shape and/or size (i.e., dimensions) of the body 902 portion of the wall expander 900 may be varied and that such variation is contemplated and within the scope of the present disclosure. As an example of variation of shape, it is to be appreciated that the face need not be a rectangle. As another example of variation of shape, it is to be appreciated that the face need not be flat. As a specific example of such, the body may have an “L” shape. The “leg” of the “L” shape may extend perpendicularly from the remainder of the “L” shape.

As shown, the wall expander 900 can include the capture feature 428 and the retention tab feature 600. The capture feature 428 and the retention tab feature 600 can be similar or identical to the capture feature 428 and the retention tab feature 600 as shown in FIGS. 5A, 5B, 6A, and 6B. It is to be appreciated that if the capture feature 428 and the retention tab feature 600 are identical at every occasion of their use in the present disclosure, a modular design can provide particular benefits. For example, as the tray support tabs 208 are detached from the slack storage basket 400 (shown in FIG. 8), the wall expander 900 can be attached to at least one of the first side portion 404 or the second side portion 410 to increase the volume 416 of the storage 114. The described modularity of parts can be achieved, at least in part, because the retention tab feature 600 of the wall expander 900 is identical or nearly identical to the retention tab feature 600 of the tray support tab 208.

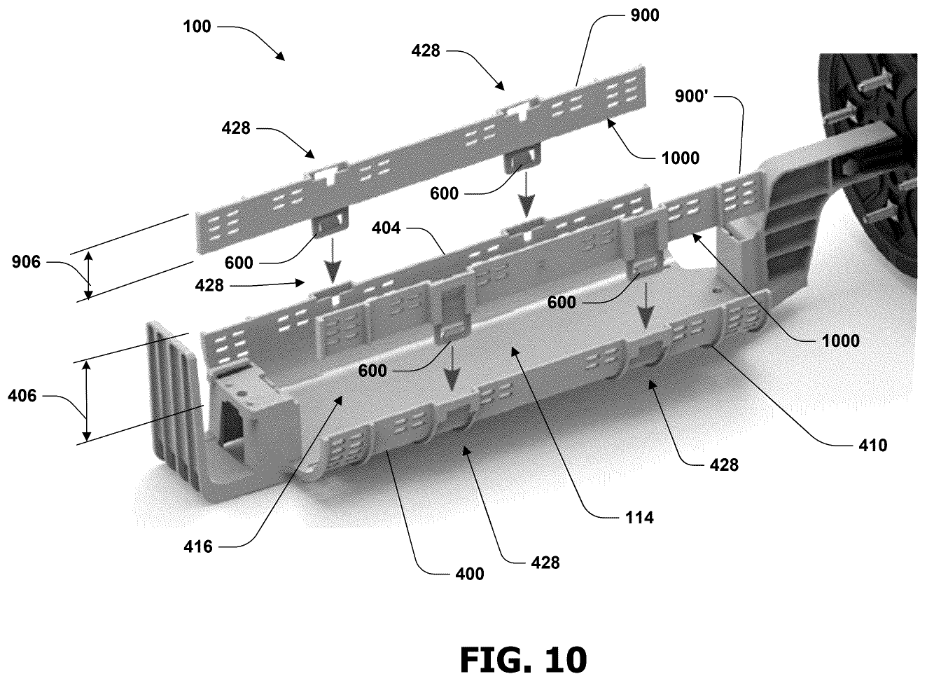

Referring to FIG. 10, a perspective view of the slack storage basket 400 is illustrated showing attachment of two wall expanders 900 (and/or 900′) to provide an increased volume 416 to the storage 114 of the slack storage basket 400. The wall expander 900, or third side portion, includes a bottom side 1000 facing the first side portion 404 of the slack storage basket 400. A first connecting structure (e.g., the retention tab feature 600) is associated with the bottom side 1000 of the wall expander 900. The first connecting structure is configured to cooperate with a second connecting structure (e.g., the capture feature 428) attached to the slack storage basket 400 such that location of the bottom side 1000 of the wall expander 900 proximate the first side portion 404 of the slack storage basket 400 places the first connecting structure in cooperation with the second connecting structure to attach the wall expander 900 to the slack storage basket 400.

Similarly, another wall expander 900′, or fourth side portion, includes a bottom side 1000 facing the second side portion 410 of the slack storage basket 400. A first connecting structure (e.g., the retention tab feature 600) is associated with the bottom side 1000 of the wall expander 900′. The first connecting structure is configured to cooperate with a second connecting structure (e.g., the capture feature 428) attached to the slack storage basket 400 such that location of the bottom side 1000 of the wall expander 900′ proximate the second side portion 410 of the slack storage basket 400 places the first connecting structure in cooperation with the second connecting structure to attach the wall expander 900′ to the slack storage basket 400.

When the wall expanders 900 and 900′ are attached to the slack storage basket 400, the first dimension 406 of the slack storage basket 400 is increased by the perpendicular dimension 906. The increase of dimension is in order to increase the volume 416 defined by the slack storage basket 400 such that an increased length of a cable may be stored in the slack storage basket 400 as compared to when the wall expanders 900 and 900′ are not attached to the slack storage basket 400.

As a brief summary, the volume 416 can be calculated by the first dimension 406 multiplied by the third dimension 418 multiplied by the fourth dimension 424 as shown in FIG. 4. The described addition of the third side portion (e.g., the wall expander 900) to the first side portion 404 and the fourth side portion (e.g., a second wall expander 900′) to the second side portion 410 will increase the volume 416. The new volume can be calculated by first finding the sum of the first dimension 406 and the perpendicular dimension 906 and then multiplying that sum by the third dimension 418 multiplied by the fourth dimension 424. Because the sum of the first dimension 406 and the perpendicular dimension 906 must be greater than the first dimension 406 alone, the calculated value for the volume 416 of the storage 114 after the addition of the third side portion and the fourth side portion must also be greater than the value for the volume 416 prior to the addition of the third side portion and the fourth side portion.

It is to be understood that these example formulae for the volume of a rectangular prism may be used to calculate an estimated volume 416 while disregarding certain geometric features of the components bounding the volume 416 that may not include right angles, lie perfectly within a single plane, etc.

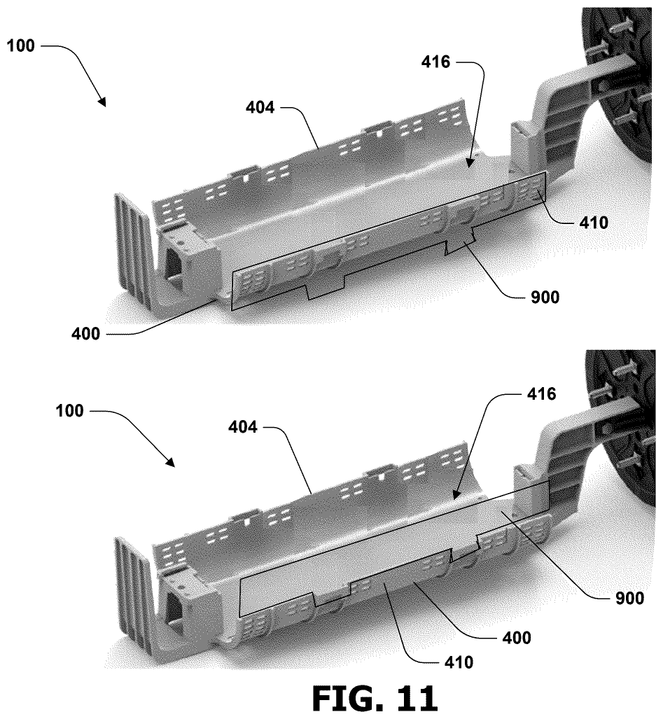

Referring to FIG. 11, a perspective view of the slack storage basket 400 is illustrated showing the wall expander 900 having a selectively slidable attachment to the slack storage tray 400. It is to be appreciated that the wall expander 900 (e.g., the third side portion and the fourth side portion) can, instead of being fully detached from the slack storage basket 400, be moveably attached to the slack storage basket 400. For example, the top illustration of FIG. 11 shows an outline of the wall expander 900 in a first position such that the wall expander 900 does not increase the volume 416 of the slack storage basket 400.

However, the wall expander 900 can have a selectively slidable attachment in any suitable arrangement such that the wall expander 900 can be slid into a second position such that the wall expander 900 is located atop the second side portion 410 to increase the volume 416 of the slack storage basket 400. The structure(s) shown in FIG. 11 provide but one example of attachment of the wall expander 900 to the slack storage basket 400 such that a need for separate parts during a field modification to the enclosure 100 is reduced or eliminated. It is to be understood that while the wall expander 900 is shown only attached to the second side portion 410, a similar or identical wall expander 900 can be attached in the same way to the first side portion 404.

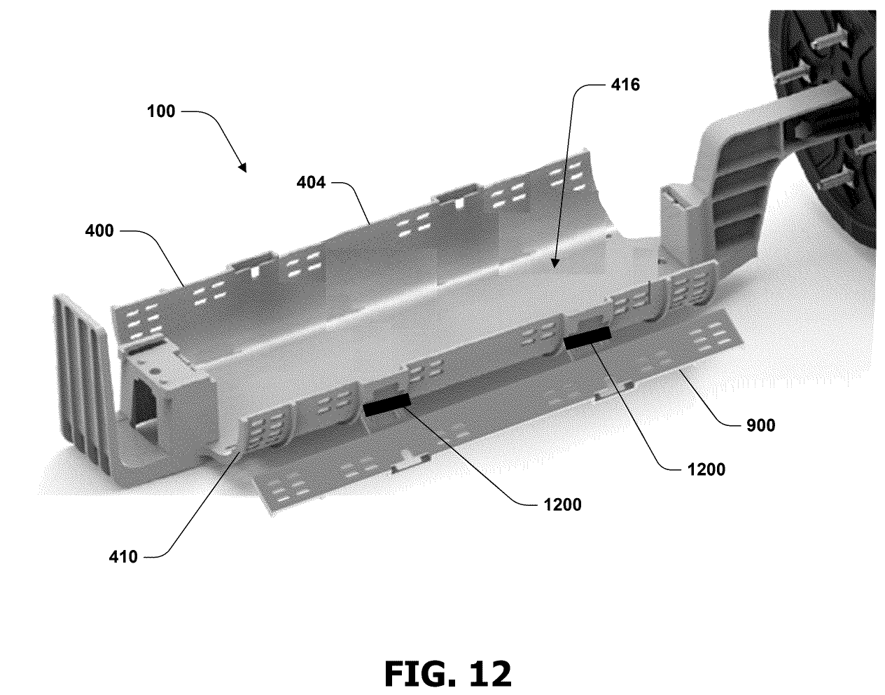

Referring to FIG. 12, a perspective view of the slack storage basket 400 illustrated with some components removed showing the wall expander 900 according to FIG. 9 having a selectively rotatable attachment to the slack storage tray 400. In some examples, the wall expander 900 can be in a first position such that the wall expander 900 does not increase the volume 416 of the slack storage basket 400. However, the wall expander 900 can have a selectively rotatable attachment in any suitable arrangement such that the wall expander 900 can be rotated into a second position such that the wall expander 900 is located atop the second side portion 410 to increase the volume 416 of the slack storage basket 400. In some examples, the wall expander 900 can be attached to the slack storage basket 400 using a hinge 1200. The structure(s) shown in FIG. 12 provide but one example of attachment of the wall expander 900 to the slack storage basket 400 such that a need for separate parts during a field modification to the enclosure 100 is reduced or eliminated. It is to be understood that while the wall expander 900 is shown only attached to the second side portion 410, a similar or identical wall expander 900 can be attached in the same way to the first side portion 404.

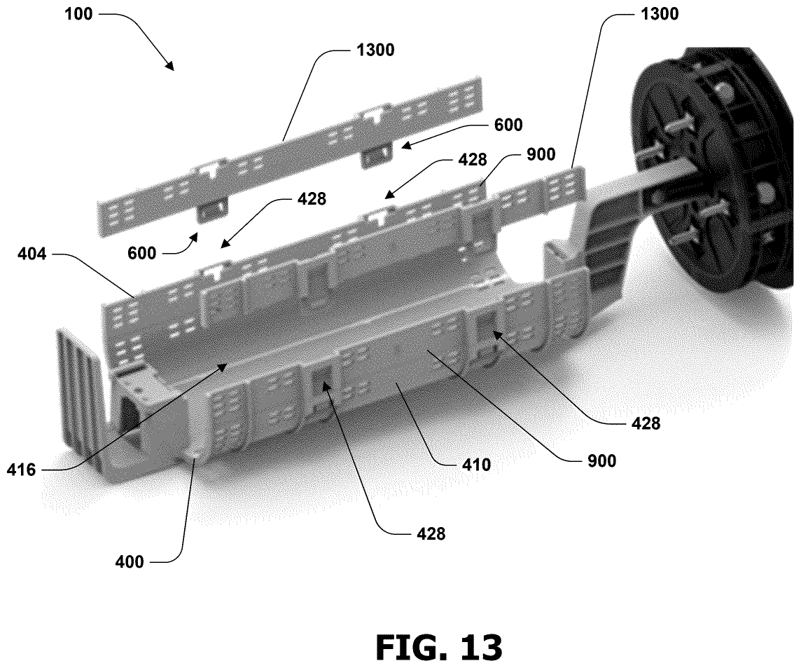

Referring to FIG. 13, a perspective view of an example interior portion of an enclosure 100 is illustrated showing additional wall expanders 1300 being attached to already placed wall expanders 900. In some examples, a desired increase of the volume 416 requires more than one wall expander 900 to attain the desired volume increase for additional slack cable storage. As previously discussed, the modular features of the described components such as the first side portion 404, the second side portion 410, the wall expander 900, the additional wall expander 1300, etc. enables multiple levels of wall expanders 900, 1300. In some examples, the additional wall expander 1300 is similar or identical to the wall expander 900. In some examples, there can be a range of wall expander geometries, dimensions, etc. to attain the desired additional volume 416.

The wall expander 1300 can be attached to the wall expander 900 above the first side portion 404 or above the second side portion 410 to increase the volume 416 of the storage 114. In some examples, the attachment of the wall expander 1300 to the wall expander 900 is the same as the previously described process. For example, the retention tab feature 600 of the wall expander 1300 cooperates with the capture feature 428 of the wall expander 900 to secure the wall expander 1300 to the wall expander 900 after urging the wall expander 1300 generally downward into contact with the wall expander 900.

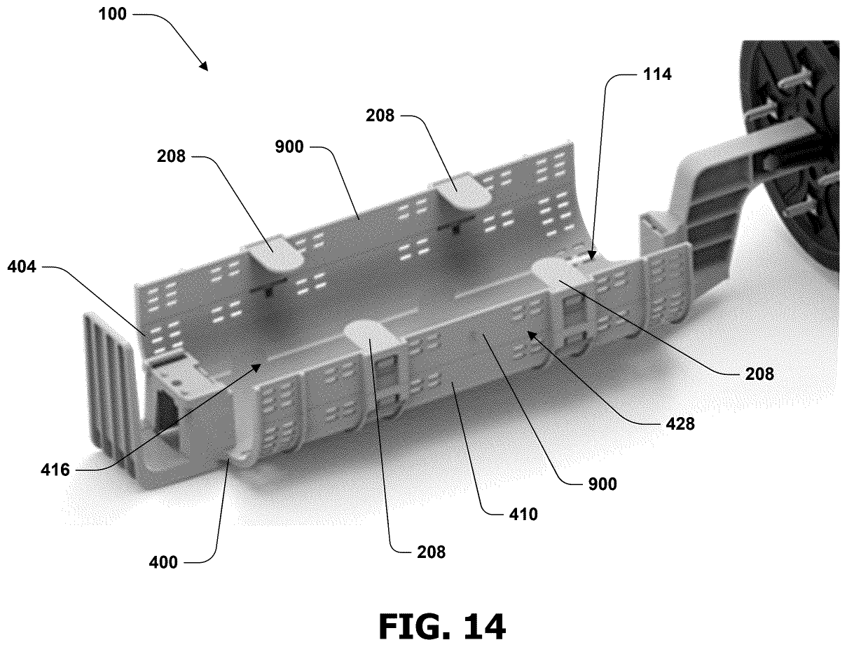

Referring to FIG. 14, a perspective view of the slack storage basket 400 is illustrated showing the wall expanders 900 attached to the slack storage basket 400 and the tray support tabs 208 attached to the wall expanders 900. The addition of the tray support tabs 208 is not required, however, as previously discussed, the tray support tabs 208 can serve multiple functions, including, but not limited to, providing a physical boundary for the wire or cable stored within the volume 416 of the storage 114 of the enclosure 100. The tray support tabs 208 can also provide a relatively firm base for one or more splice trays (an example is shown in FIG. 15) that may be stacked atop the slack storage basket 400. It is to be understood that the tray support tabs 208 can include retention tab features 600 which cooperate with capture features 428 on the slack storage basket 400. This cooperation selectively attaches the tray support tabs 208 to the wall expanders 900 as discussed in reference to FIGS. 5A, 5B, 6A, and 6B.

Referring to FIG. 15, a perspective view of the slack storage basket 400 is illustrated showing the wall expanders 900 attached to the slack storage basket 400 and a splice tray 1500 stacked atop the volume 416 expanded slack storage basket 400.

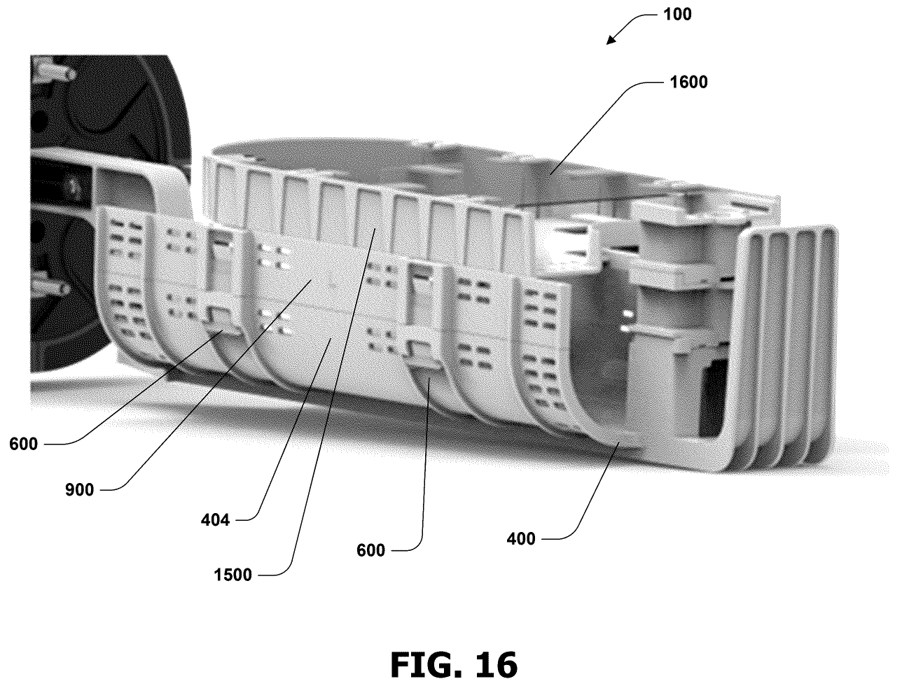

Referring to FIG. 16, a reverse-angle perspective of the example interior portion shown in FIG. 15 is illustrated. A splice tray cover 1600 is provided for organization and cable control. In the shown example, the wall expander 900 includes two retention tab features 600. The wall expander 900 on the opposite side of the slack storage basket 400 (not visible) also includes two retention tab features 600. The number and location of the retention tab features 600 configured to cooperate with the capture features 428 of the first side portion 404 and the second side portion 410 (not visible) can vary and can be determined, calculated, engineered, etc. to meet particular performance standards of the enclosure 100.

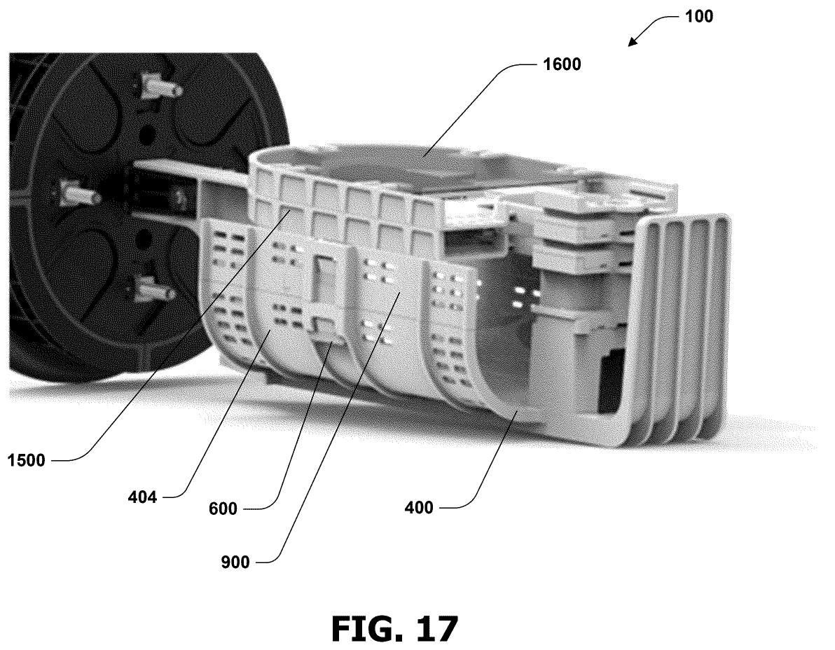

Referring to FIG. 17, a perspective illustration similar to FIG. 16, but showing a slack storage tray 400 and a splice tray 1500 of different dimension and number of attachment features. In the shown example, the wall expander 900 includes one retention tab feature 600. The wall expander 900 on the opposite side of the slack storage basket 400 (not visible) also includes one retention tab feature 600.

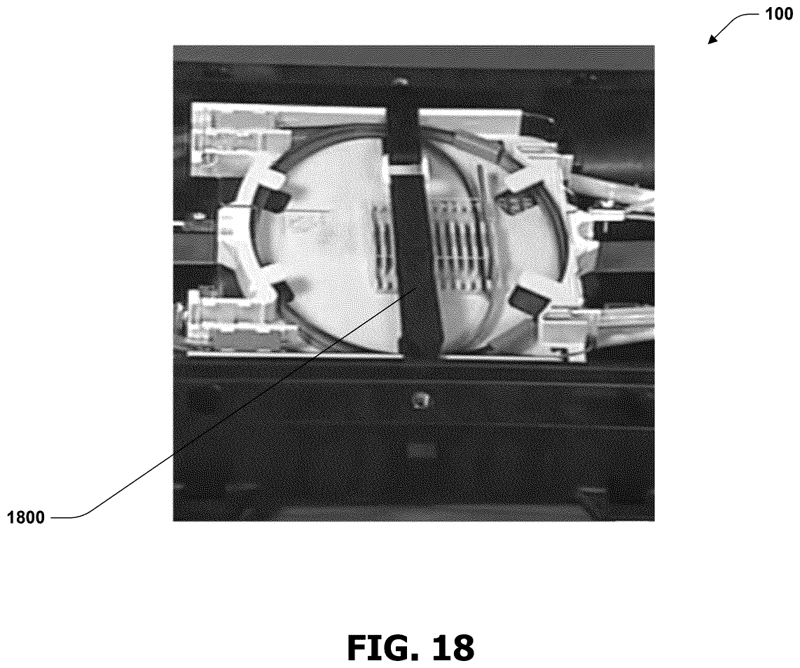

Referring to FIG. 18, a perspective view of an example interior portion of an enclosure 100 is illustrated. In some examples, a hook and loop fastener 1800 can be used to secure the slack storage basket 400, the wall expanders 900 and the splice trays 1500 to each other and to the framework of the enclosure 100. In some examples, the hook and loop fastener 1800 is long and strap-like so as to wrap around all of the listed components. The hook and loop fastener 1800 can be attached to a structural member within the enclosure 100.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first location and a second location correspond to location A and location B or two different or two identical locations or the same location.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are to be construed to mean “one or more” unless specified otherwise or clear from context to be directed to a singular form. Also, at least one of A and B or the like means A or B or both A and B. Furthermore, to the extent that “includes”, “having”, “has”, “with”, or variants thereof are used in either the detailed description or the claims, such terms are intended to be inclusive in a manner similar to “comprising.”

Also, although the disclosure has been illustrated and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above-described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. An enclosure to house a connection, the enclosure comprising:
a closure base partially defining an interior space of the enclosure, the closure base defining a point of entry for an incoming portion of a cable to enter into the interior space of the enclosure;
a closure cover mating with the closure base, the closure cover partially defining the interior space such that the closure cover and the closure base define the interior space of the enclosure, the interior space being for the connection, wherein the connection is associated with at least some of the cable;
a slack storage basket located within the interior space comprising:
a floor portion;
a first side portion attached to the floor portion, the first side portion extending a first dimension measured from an intersection of the floor portion and the first side portion taken along a first line oblique to the floor portion; and
a second side portion attached to the floor portion, the second side portion extending a second dimension measured from an intersection of the floor portion and the second side portion taken along a second line oblique to the floor portion, wherein:
the floor portion, the first side portion, and the second side portion define a volume configured to contain a length of the cable and a portion of one or more outgoing cables, the volume defined by the first dimension, the second dimension, a third dimension of the floor portion measured from a first end of the first side portion to a second end of the first side portion, and a fourth dimension of the floor portion measured from the first side portion to the second side portion,
a third side portion selectively attachable to the first side portion to increase the first dimension; and
a fourth side portion selectively attachable to the second side portion to increase the second dimension, wherein:
when at least one of the third side portion or the fourth side portion are attached to the slack storage basket, the volume is increased to store an increased length of the cable than when at least one of the third side portion or the fourth side portion is not attached to the slack storage basket.

2. The enclosure of claim 1, wherein:
the first side portion comprises at least one of:
a first tab; or
a first slot;
the third side portion comprises at least one of:
a second tab; or
a second slot; and
at least one of:
the first tab is configured to cooperate with the second slot, or
the second tab is configured to cooperate with the first slot to attach the third side portion to the first side portion.

3. The enclosure of claim 2, wherein:
the first tab is movable from a first tab position to a second tab position; and
as the third side portion is attached to the first side portion, a structure associated with the second slot provides a physical interference such that a force applied to the third side portion urges the first tab from the first tab position to the second tab position such that the first tab is elastically deformed to pass by the structure in order to pass into the second slot to attach the third side portion to the first side portion.

4. The enclosure of claim 2, wherein:
the second tab is movable from a first tab position to a second tab position,
as the third side portion is attached to the first side portion, a structure associated with the first slot provides a physical interference such that a force applied to the third side portion urges the second tab from the first tab position to the second tab position such that the second tab is elastically deformed to remove the physical interference to pass into the first slot in order to attach the third side portion to the first side portion.

5. The enclosure of claim 4, wherein:
when the second tab is in the first slot, the structure associated with the first slot provides the physical interference such that the second tab is retained within the first slot to maintain the attachment of the third side portion to the first side portion.

6. The enclosure of claim 4, wherein:
when the second tab is in the first slot, the structure associated with the first slot provides the physical interference such that the second tab is removable from the first slot by urging the second tab from the second tab position to the first tab position to detach the third side portion from the first side portion.

7. The enclosure of claim 3, wherein:
when the first tab is in the second slot, the structure associated with the second slot provides the physical interference such that the first tab is retained within the second slot to maintain the attachment of the third side portion to the first side portion.

8. The enclosure of claim 3, wherein:
when the first tab is in the second slot, the structure associated with the second slot provides the physical interference such that the first tab can be removed from the second slot by urging the first tab from the second tab position to the first tab position to detach the third side portion from the first side portion.

9. An enclosure to house a connection, the enclosure comprising:
a closure base partially defining an interior space of the enclosure, the closure base including a point of entry for an incoming portion of a cable to enter into the interior space of the enclosure;
a closure cover mating with the closure base, the closure cover partially defining the interior space such that the closure cover and the closure base define the interior space of the enclosure, the interior space being for the connection, wherein the connection is associated with at least some of the cable;
a slack storage basket located within the interior space comprising:
a floor portion;
a first side portion attached to the floor portion, the first side portion extending a first dimension measured from an intersection of the floor portion and the first side portion taken along a first line oblique to the floor portion; and
a second side portion attached to the floor portion, the second side portion extending a second dimension measured from an intersection of the floor portion and the second side portion taken along a second line oblique to the floor portion, wherein:
the floor portion, the first side portion, and the second side portion define a volume configured to contain a length of the cable and a portion of one or more outgoing cables, the volume defined by the first dimension, the second dimension, a third dimension of the floor portion measured from a first end of the second side portion to a second end of the second side portion, and a fourth dimension of the floor portion measured from the first side portion to the second side portion,
a third side portion attached to the first side portion, movable from a first position to a second position; and
a fourth side portion attached to the second side portion, movable from a third position to a fourth position, wherein:
when the third side portion is moved from the first position to the second position the first dimension is increased,
when the fourth side portion is moved from the third position to the fourth position the second dimension is increased, and
when at least one of the first dimension or the second dimension is increased, the volume is increased to store an increased length of the cable than when at least one of the first dimension or the second dimension is not increased.

10. The enclosure of claim 9, comprising:
a splice tray configured to contain at least one of cable splices, cable terminations, or cable connections; and
a retention tab attached to the slack storage basket configured to provide support to the splice tray.

11. The enclosure of claim 10, comprising a hook and loop fastener configured to secure the splice tray to the slack storage basket.

12. The enclosure of claim 9, wherein at least one of the first side portion, the second side portion, the third side portion, or the fourth side portion define an aperture configured to enable attachment of a component to the slack storage basket to limit relative motion between the component and the slack storage basket.

13. The enclosure of claim 9, wherein at least one of the third side portion or the fourth side portion comprises a capture feature configured to attach a fifth side portion, wherein:
attachment of the fifth side portion to at least one of the third side portion or the fourth side portion increases at least one of the first dimension or the second dimension.

14. A wall for a slack storage basket having a first dimension, the wall comprising:
a bottom side facing a first side portion of the slack storage basket; and
a first connecting structure associated with the bottom side of the wall and configured to cooperate with a second connecting structure attached to the slack storage basket such that location of the bottom side of the wall proximate the first side portion of the slack storage basket places the first connecting structure in cooperation with the second connecting structure to attach the wall to the slack storage basket, wherein:
when the wall is attached to the slack storage basket, the first dimension of the slack storage basket is increased in order to increase a volume defined by the slack storage basket such that an increased length of a cable may be stored in the slack storage basket as compared to when the wall is not attached to the slack storage basket.

15. The wall of claim 14, wherein the wall defines an aperture configured to enable attachment of a component to the slack storage basket to limit relative motion between the component and the slack storage basket.

16. The wall of claim 14, comprising a capture feature proximate a top surface of the wall, the capture feature configured to attach a second wall to the top surface.

17. The wall of claim 14, comprising a retention tab configured to provide support to a component adjacent to the slack storage basket.

18. A kit for adding volume to a slack storage basket of an enclosure comprising:
a first wall having a first bottom side; and
a second wall having a second bottom side, wherein:
the first bottom side of the first wall is selectively attached to a first side portion of the slack storage basket,
the second bottom side of the second wall is selectively attached to a second side portion of the slack storage basket,
when the first bottom side of the first wall is attached to the first side portion, a first dimension of the slack storage basket is increased,
when the second bottom side of the second wall is attached to the second side portion, a second dimension of the slack storage basket is increased, and
when at least one of the first dimension or the second dimension is increased, a volume of the slack storage basket of the enclosure is increased to store an increased length of a cable than when at least one of the first dimension or the second dimension is not increased.

19. The kit of claim 18, comprising a front side portion configured to be selectively attached to at least one of the first side portion or the second side portion, the front side portion having a third dimension that at least partially defines the volume of the slack storage basket.

20. The kit of claim 19, comprising a rear side portion configured to be selectively attached to at least one of the first side portion or the second side portion, the rear side portion having a fourth dimension that at least partially defines the volume of the slack storage basket.
